(19) United States
(12) Patent Application Publication
(10) Pub. No.: US 2026/0254330 A1
(43) Pub. Date: Aug. 27, 2026

(54) METHOD FOR FORMING AN ELECTRIC MOTOR USING A MANDREL ASSEMBLY

(71) Applicant: American Axle & Manufacturing, Inc., Detroit, MI (US)

(72) Inventors: James R. DERR, Livonia, MI (US); Bryan N. WAINEO, Northville, MI (US)

(21) Appl. No.: 19/162,844

(22) PCT Filed: Jan. 17, 2024
(86) PCT No.: PCT/US2024/011726

§ 371 Date: Sep. 5, 2025

Related U.S. Application Data
(60) Provisional application No. 63/450,767, filed on Mar. 8, 2023.

(51) Int. Cl. H02K 15/122

(52) U.S. Cl. CPC H02K 15/122

(57) ABSTRACT

A method for forming an electric motor that includes assembling a stator assembly to an encapsulation fixture in which a mandrel assembly with a sleeve and a mandrel core, which is at least partially positioned in a cavity of the sleeve, such that at least a portion of the mandrel assembly extends through a bore in the stator assembly; heating the encapsulation assembly to expand the sleeve of the mandrel assembly relative to the stator assembly to seal against at least a portion of an inner surface of the bore of the stator assembly; and injecting an encapsulant in a liquid form into the encapsulation fixture such that the encapsulant at least partly encapsulates the stator assembly at a portion of a void defined between a housing of the stator assembly and an outer diameter of the mandrel assembly.

### CROSS-REFERENCE TO RELATED APPLICATIONS

This application claims the benefit of U.S. Provisional Application No. 63/450767 filed Mar. 8, 2023, the disclosure of which is incorporated by reference as if fully set forth in detail herein.

### FIELD

The present disclosure relates to forming an electric motor, and more particularly, forming a stator assembly of the electric motor.

### BACKGROUND

This section provides background information related to the present disclosure which is not necessarily prior art.

With present day electric motors, the teeth of a stator are typically wound with electrically conductive wire. The electrically conductive wire is typically wrapped a number of times around each tooth of the stator. Sometimes wire having a round cross-sectional configuration is used and sometimes wire in the form of a ribbon is used. In either event, however, the winding process typically leaves a plurality of voids between adjacent portions of the conductive wire. The voids are undesirable from the standpoint that they inhibit the thermal conduction of heat out from the conductive windings to the stator material. This can lead to an unacceptable heat buildup in the stator.

### SUMMARY

This section provides a general summary of the disclosure, and is not a comprehensive disclosure of its full scope or all of its features.

In one form, the present disclosure provides a method for forming an electric motor. The method includes: providing a stator assembly having a stator core and a set of windings, the stator core defining a bore, the windings being coupled to the stator core; assembling the stator assembly to an encapsulation fixture to form an encapsulation assembly, the encapsulation fixture having at least a mandrel assembly that includes a mandrel core and a sleeve, at least a portion of the mandrel assembly extending through the bore in the stator core; heating the encapsulation assembly to expand the sleeve of the mandrel assembly relative to the stator core to seal against at least a portion of an inner surface of the bore of the stator core; injecting an encapsulant in a liquid form into the encapsulation assembly to have the encapsulant at least partly encapsulate the stator assembly; at least partly curing the encapsulant to form an at least partly encapsulated stator assembly; and separating the at least partly encapsulated stator assembly from the encapsulation fixture. In another form, the present disclosure provides a method for forming an electric motor. The method includes providing a stator assembly having a stator core and a set of windings, the stator core defining a bore, and the windings being coupled to the stator core; providing a mandrel assembly including a mandrel core and a sleeve, the mandrel core being at least partially positioned in a cavity of the sleeve; assembling the mandrel assembly to the bore of the stator core to have a portion of the mandrel assembly extend through the bore of the stator core of the stator assembly; heating the stator assembly with at least the mandrel assembly to expand the sleeve of the mandrel assembly relative to the stator core to seal against at least a portion of an inner surface of the bore of the stator core; injecting an encapsulant in a liquid form into the stator assembly to have the encapsulant at least partly encapsulates the stator assembly; at least partly curing the encapsulant to form an at least partly encapsulated stator assembly; and removing the at least partly encapsulated stator assembly from the mandrel assembly after at least one of the at least partly encapsulated stator assembly and the mandrel assembly has cooled such that the sleeve no longer seals the inner surface of the bore of the stator core.

In yet another form, the present disclosure provides a method for forming an electric motor. The method includes: providing a stator assembly having a housing, a stator core and a set of windings, the stator core defining a bore, the windings being coupled to the stator core, and the stator core and the windings being disposed in the housing; assembling the stator assembly to an encapsulation fixture to form an encapsulation assembly, the encapsulation fixture having at least a mandrel assembly that includes a mandrel core and a sleeve, the mandrel core being at least partially positioned in a cavity of the sleeve, and at least a portion of the mandrel assembly extending through the bore in the stator core; heating the encapsulation assembly to expand the sleeve of the mandrel assembly relative to the stator core to seal against at least a portion of an inner surface of the bore of the stator core; injecting an encapsulant in a liquid form into the encapsulation assembly to have the encapsulant at least partly encapsulates the stator assembly at a portion of a void defined between the housing and an outer diameter of the mandrel assembly; at least partly curing the encapsulant to form an at least partly encapsulated stator assembly; and separating the at least partly encapsulated stator assembly from the encapsulation fixture after the encapsulation assembly has cooled to a point where the sleeve no longer seals the inner surface of the bore of the stator core.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B are perspective views of a stator assembly with an encapsulation fixture in accordance with the teachings of the present disclosure;

FIG. 2 is a partial exploded view of the encapsulation fixture and the stator assembly without the housing in accordance with the teachings of the present disclosure;

FIG. 3 is a cross-sectional view of the encapsulation fixture and the stator assembly without the housing in accordance with the teachings of the present disclosure;

FIG. 4 is a partial exploded view of the stator assembly and a second form of an encapsulation fixture in accordance with the teachings of the present disclosure;

FIG. 5 is a cross-sectional view of the stator assembly and the second form of the encapsulation fixture in accordance with the teachings of the present disclosure; and

FIG. 6 is a perspective view of a portion of a third form of the encapsulation fixture in accordance with the teachings of the present disclosure.

Corresponding reference numerals indicate corresponding parts throughout the several views of the drawings.

### DETAILED DESCRIPTION

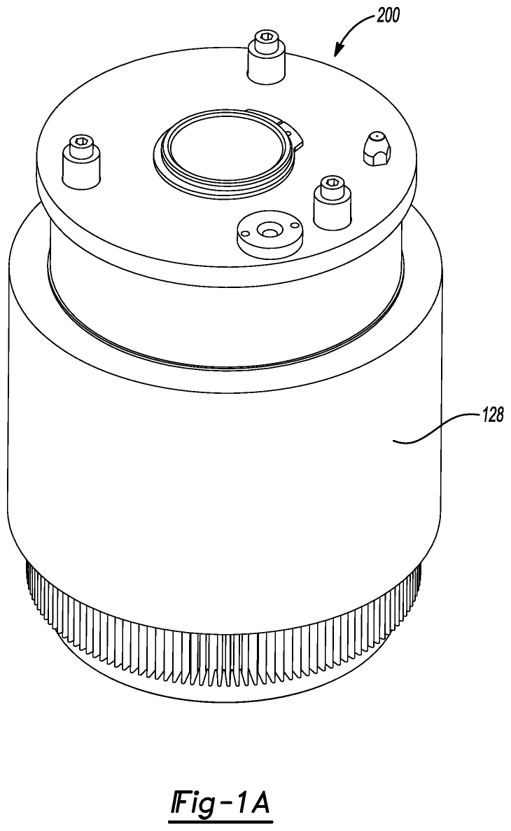

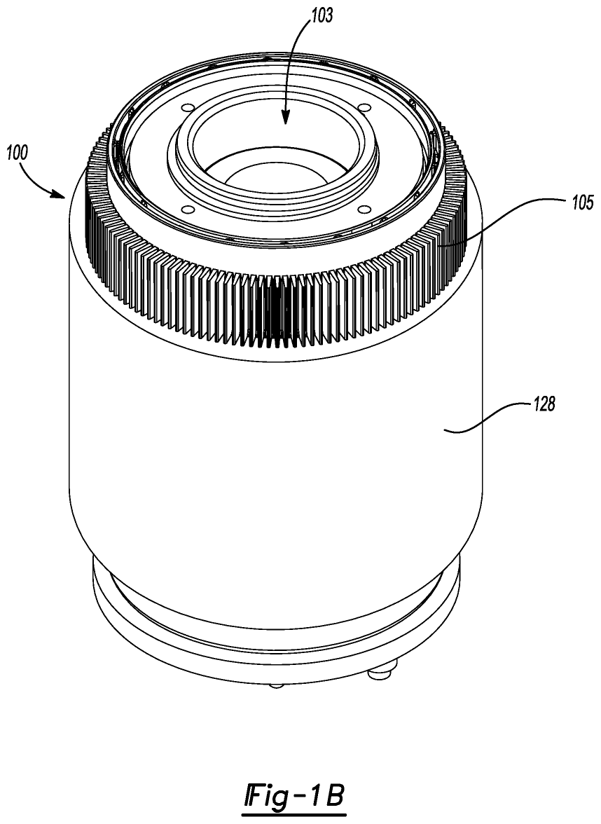

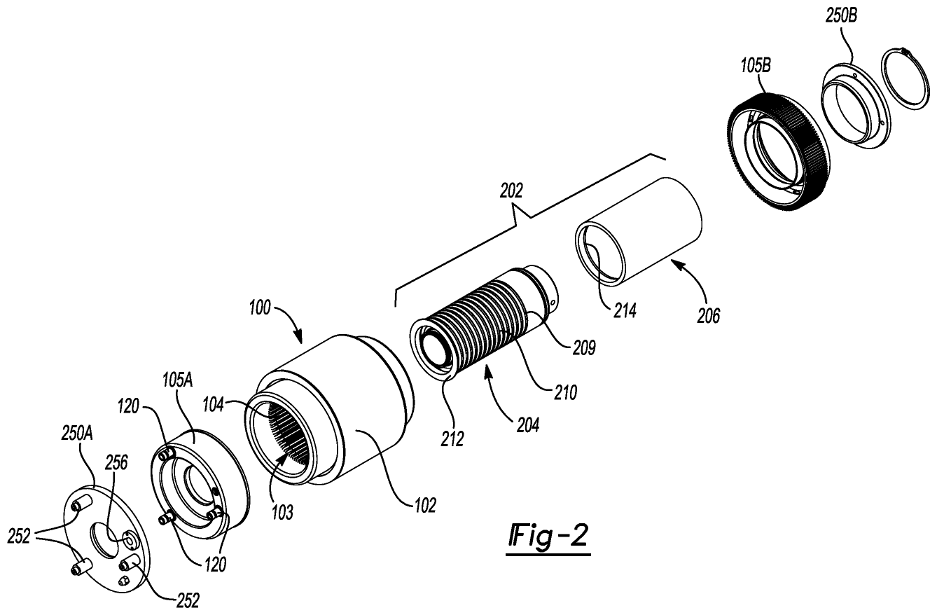

Referring to FIGS. 1 and 2, a stator assembly 100 for an electric motor generally includes a stator core 102, a set of winding 104 coupled to the stator core 102, and, in some applications, one or more endcaps 105A, 105B (i.e., also referred to as “stator cap”) arranged on opposite ends of the stator assembly 100. The stator core 102 defines a bore 103 for receiving a rotor assembly (not shown) and has a plurality of teeth that define a plurality of slots between adjacent teeth. The set of windings 104 are coupled to, or more specifically, wrapped about the plurality of teeth. In an example application, the stator core 102 is provided as a monolithic structure. In another example, the stator core 102 is formed by a plurality of lamination discs stackably arranged and fixedly secured to each other.

Generally, voids between the windings 104 and the stator core 102 may inhibit thermal conduction of heat from the windings 104 to the stator core 102 leading to an unacceptable heat buildup in the stator assembly 100. To improve thermal conduction, the stator assembly 100 is at least partly encapsulated with an encapsulant, such as polymer based liquid as part of encapsulation process. The encapsulant is provided to fill voids between the stator core 102 and the set of windings 104. The encapsulant may also be used to fill other voids of the stator assembly 100 such as, but not limited to, voids about the pair of endcaps and end-turns of the set of windings 104 of the stator assembly 100.

The bore 103 of the stator assembly 100 is generally not encapsulated, so as to provide a smooth surface for the rotor assembly. More particularly, the rotor assembly rotates within the bore 103 the of the stator assembly 100 and thus, the surface of the bore 103 is provided with little to no encapsulant. As described herein, the present disclosure provides an encapsulation method employing an encapsulation fixture 200 having a mandrel assembly 202 that inhibits or reduces the amount of encapsulant entering the bore 103.

In one form, the mandrel assembly 202 includes a mandrel core 204 and a sleeve 206. The mandrel core 204 supports the sleeve 206 and may be made of various suitable material, such as, but not limited to: steel, aluminum alloy, or other alloy. In one form, the mandrel core 204 defines an opening 208 and includes a set of grooves 209 (i.e., “grooves 209” hereinafter) defining a set of ridges 210 along an outer surface of the mandrel core 204. In the example provided in FIGS. 1A, 1B, 2 and 3, the mandrel core 204 is provided as a multi-piece structure in which the pieces are secured to one another to provide a core that accommodates thermal expansion and component variation. For example, the mandrel core 204 includes an inner core 212 defining the opening 208 and an outer core 214 having the ridges 210. The inner core 212 includes a biasing device 216, such as a spring, that is arranged about an exterior of the inner core 212 with one end secured to the inner core 212 and another end secured by a fastening device, such as a washer 218 and a clip 220. The outer core 214 defines a hole 222 to receive and house at least a portion of the inner core 212, and defines a groove 224 for the clip 220. The biasing device 216 extends and is compressible between the inner core 212 and the outer core 214 to allow the inner core 212 to move along a longitudinal axis of the mandrel assembly 202. The longitudinal axis is generally provided by line 225. The outer core 214 of the mandrel assembly 202 extends to one end of the stator assembly 100 and the inner core 212 of the mandrel assembly 202 extends to the other end of the stator assembly 100. The mandrel core 204 is adjustable in length to accommodate stator assemblies of different lengths. Specifically, a length of the mandrel core 204 is compliant to accommodate, for example, variations in length and/or thermal expansion while maintaining a clamping force on the stator assembly 100.

While the fastening device for securing the biasing device 216 is illustrated as having the washer 218 and the clip 220, the other suitable fastening devices may be provided such as, but not limited to, a plate welded to or formed with the outer core 214. In addition, while the mandrel core 204 is provided as a multiple piece component, the mandrel core 204 may be provided as a single monolithic piece of material with a fixed length.

In one form, the sleeve 206 is made of an elastomeric material that expands when heated, such as, but not limited to, a silicone-based material. The sleeve 206 defines a cavity and the mandrel core 204 is at least partially positioned in the cavity supporting the sleeve 206. More particularly, the sleeve 206 is configured to be placed over and removable from the mandrel core 204. The sleeve 206 generally aligns with the ridges 210 of the mandrel core 204.

In some applications, the mandrel core 204 and the sleeve 206 may include additional features for aligning and connecting to each other. For example, the mandrel core 204 includes a rim 230 and the sleeve 206 has a circumferential recess 232 along the inner surface to receive or, in other words, engage with the rim 230 of the mandrel core 204.

As further described below, with the sleeve 206 arranged on the mandrel core 204, the mandrel assembly 202 is assembled to the bore 103 of the stator core 102 or, in other words, inserted in the bore 103 with a portion of the mandrel assembly 202 extending through the bore 103. Together, the stator assembly 100 and the encapsulation fixture 200, which at least has the mandrel assembly 202, may be referred to as an encapsulation assembly. The encapsulation assembly is provided in, for example, an industrial oven, where it is heated to increase the temperature of the stator assembly 100 and to seal the bore 103. Specifically, during the heating process, the sleeve 206 expands relative to the stator core 102 and seals against at least a portion of an inner surface of the bore 103 of the stator core 102. In some instances, the sleeve 206 may also expand into the grooves 209 of the mandrel core 204 sealing the space between the inner surface of the stator core 102 and the mandrel assembly 202. The encapsulation assembly is heated based on one or more heating parameters such as, but not limited to, one or more temperature settings for an industrial oven employed for heating the encapsulation assembly and a heating time period.

Once heated, the encapsulation assembly is injected with the encapsulant, and in some applications, the encapsulant is provided at the bottom of the encapsulation assembly to be pushed through the stator assembly 100 from bottom to top. For example, the stator assembly 100 has a first axial end (generally referenced by reference number 110) and a second axial end (generally referenced by reference number 112) opposite of the first axial end 110, and the encapsulation assembly is arranged to have the first axial end 110 of the stator assembly 100 positioned lower than the second axial end 112 of the stator assembly 100. The encapsulant is provided at the first axial end 110 of the stator assembly 100 such that the encapsulant is forced through the stator assembly 100 to the second axial end 112 of the stator assembly 100. The bore 103 is sealed by the mandrel assembly 202 inhibiting the encapsulant from entering the bore 103.

Once injected, the encapsulant is at least partly curried to form an at least partly encapsulated stator assembly 100. Specifically, the encapsulation assembly is heated in the industrial oven to at least partly cure the encapsulant. The encapsulation assembly is then cooled to a point where the sleeve 206 no longer seals the inner surface of the bore 103 of the stator core 102. Once cooled, the stator assembly 100 is then removed from the encapsulation fixture 200. For example, the mandrel assembly 202 is removed from the stator assembly 100 separating the at least partly encapsulated stator assembly 100 from the encapsulation fixture 200. With the sleeve 206 and mandrel core 204, the bore 103 of the stator assembly 100 has little to no encapsulant providing a substantially smooth surface for the rotor assembly.

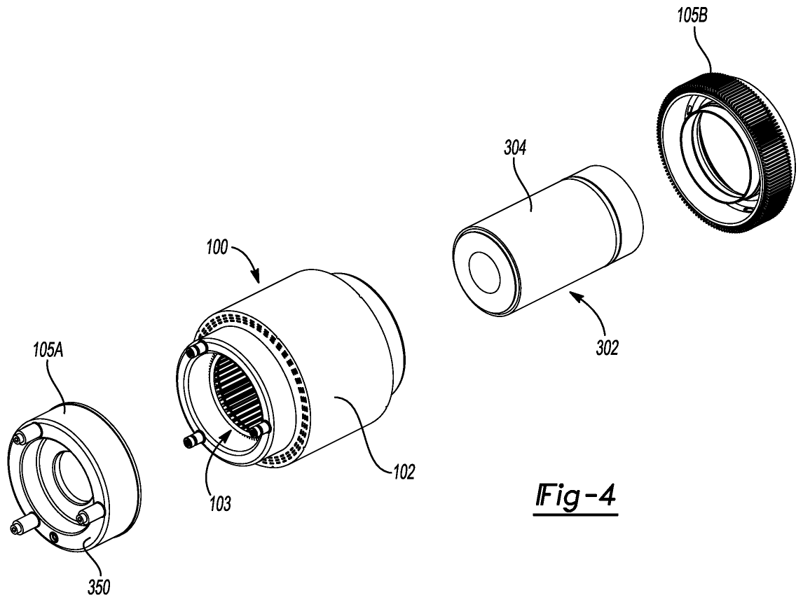

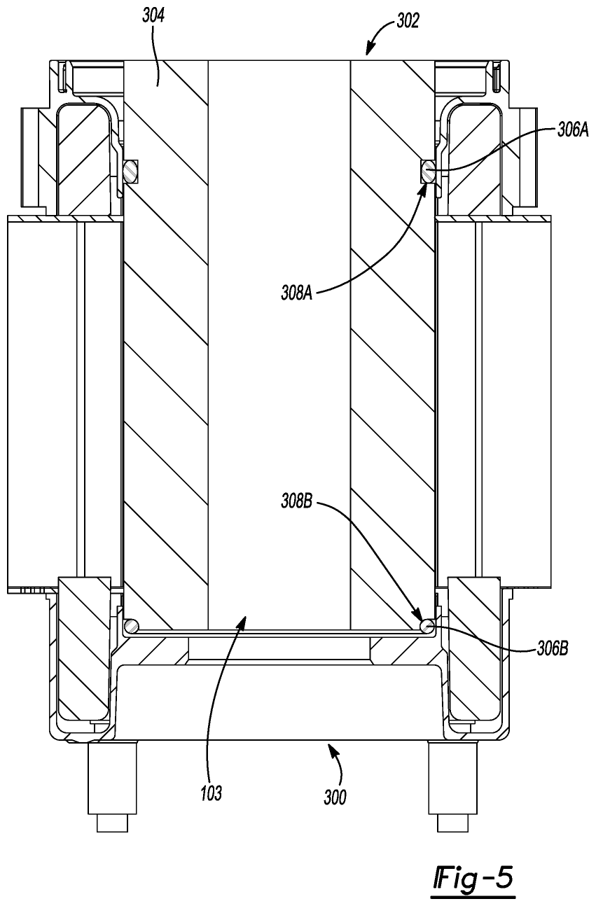

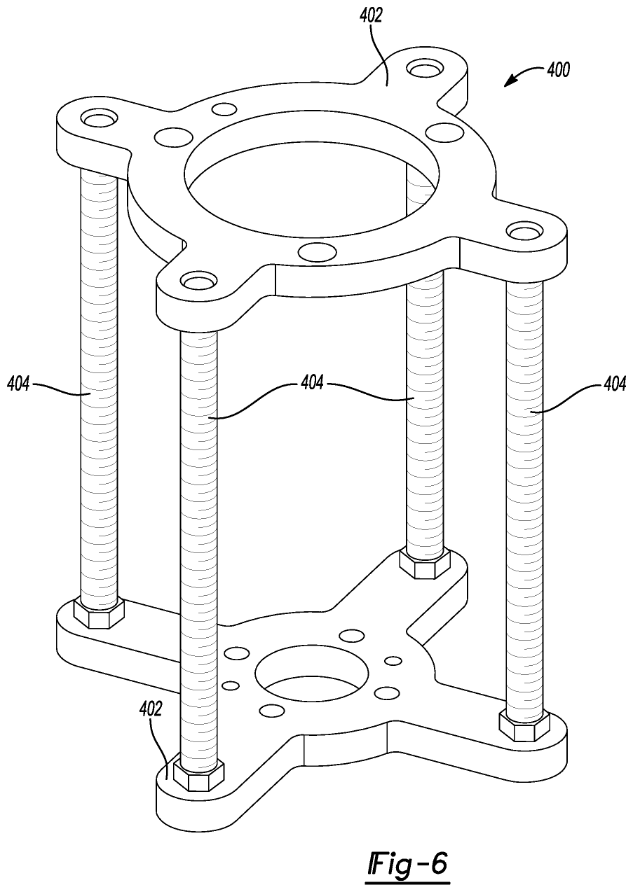

Referring to FIGS. 4 and 5, in lieu of a two-piece mandrel assembly 202, an encapsulation fixture 300 may include a mandrel assembly 302 having a mandrel 304 that is adapted to at least partially extend through the bore 103 of the stator assembly 100. In one form, the mandrel 304 is adapted to have a slip fit with the stator core 102, and more particularly, an outer diameter of the mandrel 304 is less than the inner diameter of the stator core 102, but is as close enough to the stator core 102 as possible to inhibit or reduce the amount of encapsulant from entering the bore 103. The mandrel 304 is adapted to inhibit bonding with the encapsulant mandrel. For example, the outer surface of the mandrel 304 is substantially smooth to inhibit or reduce encapsulant from adhering to a surface of the mandrel 304. The mandrel assembly 202 further includes seals 306A, 306B for containing the encapsulant between the stator core 102 and the mandrel 304. For example, the mandrel defines multiple seal grooves 308A, 308B at opposite ends, and the seal 306A is arranged at the seal groove 308A at one end of the mandrel 304 and the seal 306B is arranged at the groove 308B at a second end of the mandrel 304 opposite the first end.

With the mandrel assembly 302, the encapsulation process is similar to that of the mandrel assembly 202. More particularly, the mandrel assembly 302 having the mandrel 304 is assembled to the bore 103 of the stator core 102 or, in other words, inserted in the bore 103. The encapsulation assembly having the mandrel assembly 302 and the stator assembly 100 is heated to increase the temperature of the stator assembly 100. Since there is no sleeve, the heating parameters for the encapsulation assembly having the encapsulation fixture 300 may be different from that of the encapsulation assembly having the mandrel assembly 202.

Once heated and similar to the encapsulation assembly having the mandrel assembly 202, the encapsulation assembly is injected with the encapsulant from a bottom portion of the encapsulation fixture 300. The mandrel 304 inhibits or substantially reduces the amount of encapsulant from entering the bore 103 since the gap between the mandrel 304 and the bore 103 is reduced to provide enough movement for the mandrel 304 to be removed from the bore 103. Once injected, the encapsulant is at least partly curried to form the at least partly encapsulated stator assembly. Without the expanded sleeve 206 sealing against the bore 203, the encapsulation fixture 300 may be removed at a suitable time after the encapsulant is curried. Accordingly, the stator assembly 100 is removed from the encapsulation fixture 300.

The following are different variations that can be applied to an encapsulation fixture having the mandrel assembly 202 or the mandrel assembly 302.

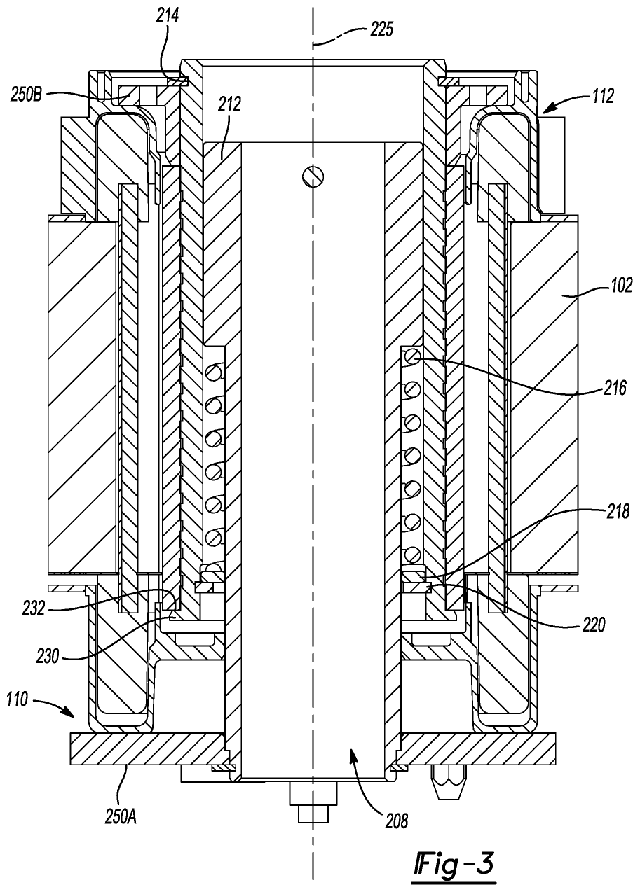

In some variations, referring back to FIGS. 2 and 3, the encapsulation fixture 200 further includes one or more endplates 250A, 250B that are disposed on opposite ends of the mandrel assembly 202. More specifically, when assembling the stator assembly 100 in the encapsulation fixture, the endplates 250A, 250B are arranged to at least partially close opposite ends of the stator assembly 100. In one form, the endplates 250A, 250B may be secured via fasteners, such as, but not limited to, a clip 251 and screws (not shown) to be provided in features 252. It should be readily understood that one or more endplates may also be provided with the encapsulation fixture 300.

In some variations, the encapsulation assembly having the endplates 250A, 250B are connected via a support rod. For example, referring to FIG. 5, an encapsulation fixture 400, which may be used with the mandrel assembly 202 or the mandrel assembly 302 includes two endplates 402 and multiple support posts 404 extending between the endplates 402. Once assembled, the encapsulation assembly having the encapsulation fixture 400 provides a clamping force that is exerted through the endplates 402 to the stator assembly 100 and the mandrel assembly 202,302.

With continuing reference to FIGS. 2 and 3, in some variations, the endplate 250A provided at lower end of the encapsulation assembly defines an inlet port 256 to connect to connect to an encapsulant supply system (not shown) to receive the encapsulant. While one inlet port 256 is provided, multiple inlet ports may be used.

In some applications, at least one of the endplates 250A, 250B of the encapsulation fixture 200 may be include features to be used to align with the stator cap 105A, 105B of the stator assembly 100. For example, the endplate 250A includes the features 252 that align with features 120 of the stator cap 105A.

With continuing reference to FIGS. 1A and 1B, in some applications, the stator assembly 100 further include a housing 128 having the stator core 102 and the set of windings 104 arranged therein. When injecting the encapsulant into the encapsulation assembly, the encapsulant is further provided to a portion of a void defined between the housing 128 and an outer diameter of the mandrel assembly 202,302.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for forming an electric motor, the method comprising:
providing a stator assembly having a stator core and a set of windings, the stator core defining a bore, the set of windings being coupled to the stator core;
assembling the stator assembly to an encapsulation fixture to form an encapsulation assembly, the encapsulation fixture having at least a mandrel assembly that includes a mandrel core and a sleeve, at least a portion of the mandrel assembly extending through the bore in the stator core;
heating the encapsulation assembly to expand the sleeve of the mandrel assembly relative to the stator core to form a seal between the sleeve and at least a portion of an inner surface of the bore of the stator core;
injecting an encapsulant in a liquid form into the encapsulation assembly such that the encapsulant at least partly encapsulates the stator assembly;
at least partly curing the encapsulant in the encapsulation assembly to form an at least partly encapsulated stator assembly; and
separating the at least partly encapsulated stator assembly from the encapsulation fixture.

2. The method of claim 1, wherein the sleeve is made of an elastomeric material.

3. The method of claim 2, wherein the elastomeric material is a silicone-based material.

4. The method of claim 1 further comprising providing the mandrel assembly having the mandrel core at least partially positioned in a cavity of the sleeve supporting the sleeve.

5. The method of claim 1, wherein the stator assembly further includes a stator cap arranged at an axial end of the stator core, the encapsulation fixture further includes an endplate, and the assembling the stator assembly to the encapsulation fixture further comprises aligning the stator cap of the stator assembly with the endplate of the encapsulation fixture.

6. The method of claim 1, wherein:
the encapsulation fixture further includes two endplates, and
the assembling the stator assembly to the encapsulation fixture further comprises:
at least partially closing opposite ends of the stator assembly with the two endplates; and
providing a clamping force exerted through the two endplates to the stator assembly and the mandrel assembly.

7. The method of claim 1, wherein the stator assembly has a first axial end and a second axial end opposite of the first axial end, and
the injecting the encapsulant into the encapsulation assembly further comprises:
positioning the encapsulation assembly to have the first axial end of the stator assembly be lower than the second axial end of the stator assembly; and
providing the encapsulant at the first axial end of the stator assembly to force the encapsulant through the stator assembly to the second axial end of the stator assembly.

8. The method of claim 1, wherein the stator assembly further includes a housing having the stator core and the set of windings arranged therein, and
the injecting the encapsulant into the encapsulation assembly further comprises providing the encapsulant to a portion of a void defined between the housing and an outer diameter of the mandrel assembly.

9. The method of claim 1 further comprising removing the stator assembly from the encapsulation fixture including the mandrel assembly after the encapsulation assembly has cooled to a point where the sleeve no longer seals the inner surface of the bore of the stator core.

10. A method for forming an electric motor, the method comprising:
providing a stator assembly having a stator core and a set of windings, the stator core defining a bore, and the windings being coupled to the stator core;
providing a mandrel assembly including a mandrel core and a sleeve, the mandrel core being at least partially positioned in a cavity of the sleeve;
assembling the mandrel assembly to the bore of the stator core to have a portion of the mandrel assembly extend through the bore of the stator core of the stator assembly;
heating the stator assembly with at least the mandrel assembly to expand the sleeve of the mandrel assembly relative to the stator core to seal against at least a portion of an inner surface of the bore of the stator core;
injecting an encapsulant in a liquid form into the stator assembly to have the encapsulant at least partly encapsulates the stator assembly;
at least partly curing the encapsulant to form an at least partly encapsulated stator assembly; and
removing the at least partly encapsulated stator assembly from the mandrel assembly after at least one of the at least partly encapsulated stator assembly and the mandrel assembly has cooled such that the sleeve no longer seals the inner surface of the bore of the stator core.

11. The method of claim 10, wherein the sleeve is made of an elastomeric material.

12. The method of claim 11, wherein the elastomeric material is a silicone-based material.

13. The method of claim 10 further comprising at least partially closing opposite axial ends of the stator assembly with two endplates; and
providing a clamping force exerted through the two endplates to the stator assembly and the mandrel assembly.

14. The method of claim 13, wherein the stator assembly further includes a stator cap provided at an axial end of the stator core of the stator assembly, and
the at least partially closing opposite axial ends of the stator assembly further comprises aligning a first endplate from among the two endplates to the stator cap of the stator assembly.

15. The method of claim 10, wherein the stator assembly has a first axial end and a second axial end opposite of the first axial end, and
the injecting the encapsulant further comprises:
positioning the stator assembly to have the first axial end of the stator assembly lower than the second axial end of the stator assembly; and
providing the encapsulant at the first axial end of the stator assembly to force the encapsulant is forced through the stator assembly to the second axial end of the stator assembly.

16. The method of claim 10, wherein the stator assembly further includes a housing having the stator core and the set of windings disposed therein, and
the injecting the encapsulant further comprises providing the encapsulant to a portion of a void defined between the housing and an outer diameter of the mandrel assembly.

17. A method for forming an electric motor, the method comprising:
providing a stator assembly having a housing, a stator core and a set of windings, the stator core defining a bore, the windings being coupled to the stator core, and the stator core and the windings being disposed in the housing;
assembling the stator assembly to an encapsulation fixture to form an encapsulation assembly, the encapsulation fixture having at least a mandrel assembly that includes a mandrel core and a sleeve, the mandrel core being at least partially positioned in a cavity of the sleeve, and at least a portion of the mandrel assembly extending through the bore in the stator core;
heating the encapsulation assembly to expand the sleeve of the mandrel assembly relative to the stator core to seal against at least a portion of an inner surface of the bore of the stator core;
injecting an encapsulant in a liquid form into the encapsulation assembly to have the encapsulant at least partly encapsulates the stator assembly at a portion of a void defined between the housing and an outer diameter of the mandrel assembly;
at least partly curing the encapsulant to form an at least partly encapsulated stator assembly; and
separating the at least partly encapsulated stator assembly from the encapsulation fixture after the encapsulation assembly has cooled to a point where the sleeve no longer seals the inner surface of the bore of the stator core.

18. The method of claim 17, wherein the sleeve is made of an elastomeric material.

19. The method of claim 18, wherein the elastomeric material is a silicone-based material.

20. The method of claim 17, wherein the encapsulation fixture further includes two endplates, and
the assembling the stator assembly to the encapsulation fixture further comprises:
at least partially closing opposite ends of the stator assembly with the two endplates; and
providing a clamping force exerted through the two endplates to the stator assembly and the mandrel assembly.
